(19) United States
(12) Patent Application Publication
(10) Pub. No.: US 2007/0245327 A1
(43) Pub. Date: Oct. 18, 2007

(54) Method and System for Producing Process Flow Models from Source Code

(75) Inventors: Mark D. Dietz, St. Paul, MN (US); Robert C. McCroskey, Burnsville, MN (US); Darryl G. Busch, Eden Prairie, MN (US); Daniel P. Johnson, Fridley, MN (US); Harold C. Voges, Shoreview, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/279,989

(22) Filed: Apr. 17, 2006

(51) Int. Cl. G06F 9/45

(52) U.S. Cl. 717/143; 717/136

(57) ABSTRACT

A method of extracting process flow data from a source code is provided. The method comprises parsing the source code with a plurality of regular expressions to identify a plurality of elements and at least one relationship between two or more identified element, and generating a model of the source code process flow based on the plurality of identified elements and the at least one relationship between two or more identified elements.

### GOVERNMENT LICENSE RIGHTS

The U.S. Government may have certain rights in the present invention as provided for by the terms of a Government contract.

### BACKGROUND

Many program applications have been written to perform particular tasks. For example, test programs have been written to test and identify faults in electronic equipment. However, these programs are often only designed to independently run a series of tests on a particular electronic unit to determine faults in the electronic unit. They lack the ability to make intelligent decisions and/or interactively function with other test software. To compensate for this lack of ability, a decision support system can be implemented. A decision support system is a system which collects and analyzes data and the test software in order to make intelligent decisions about how and when the test software is to be run.

In order to design a decision support system which has the ability to augment the test software with intelligent decision making, it is important for the decision support system to have access to and analyze the process flow of the different test software. However, analyzing the process flow can be extremely complex due in part to the many different decision branches which can be taken during the course of running the test software. A decision branch is a branch of the source code which is run if a particular outcome of a test occurs. For example, if a test fails, one branch of the test software is run, whereas if the test passes, a different branch is run. The task of analyzing the process flow for multiple test programs is further complicated by the fact that each test program is often written in either different programming languages and/or different variations in syntax or vocabularies of the same programming language.

### SUMMARY

The above-mentioned problems and other problems are resolved by the present invention and will be understood by reading and studying the following specification.

In one embodiment, a method of extracting process flow data from a source code is provided. The method comprises parsing the source code with a plurality of regular expressions to identify a plurality of elements and at least one relationship between two or more identified element, and generating a model of the source code process flow based on the plurality of identified elements and the at least one relationship between two or more identified elements.

In another embodiment, a system adapted to analyze source code is provided. The system comprises a parser adapted to parse a source code with a plurality of regular expressions to identify a plurality of elements and at least one relationship between two or more identified elements, and a model generator adapted to generate a model of the source code process flow based on the plurality of identified elements and the at least one relationship.

In yet another embodiment, a computer program product comprising a computer-usable medium having computer-readable code embodied therein for configuring a computer processor is provided. The computer-readable code comprises first executable computer-readable code configured to cause a computer processor to parse a source code using at least one regular expression in order to identify a plurality of elements and at least one relationship between two or more identified elements and second executable computer-readable code configured to cause a computer processor to generate a model of the source code process flow based on the plurality of identified elements and the at least one relationship.

### DRAWINGS

The present invention can be more easily understood and further advantages and uses thereof more readily apparent, when considered in view of the description of the preferred embodiments and the following figures in which:

FIG. 1 is a high level block diagram of a system for producing a process flow model from source code according to one embodiment of the present invention.

FIG. 2 is an exemplary source code to be parsed according to one embodiment of the present invention.

FIG. 3 is an exemplary parser output according to one embodiment of the present invention.

FIG. 4 is an exemplary process flow model according to one embodiment of the present invention.

FIG. 5 is a flow chart showing a method of generating a process flow model from source code according to one embodiment of the present invention.

FIG. 6 is a flow chart showing a method of parsing a source code according to one embodiment of the present invention.

FIG. 7 is a flow chart showing a method of parsing a procedure in source code according to one embodiment of the present invention.

FIG. 8 is a flow chart showing a method of generating a procedure flow according to one embodiment of the present invention.

FIG. 9 is a flow chart showing a method of inserting data regarding procedure flow into a parser output according to one embodiment of the present invention.

FIG. 10 is a high level block diagram of a processing unit according to one embodiment of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. It should be understood that the exemplary method illustrated may include additional or fewer steps or may be performed in the context of a larger processing scheme. Furthermore, the method presented in the drawing figures or the specification is not to be construed as limiting the order in which the individual steps may be performed. The following detailed description is, therefore, not to be taken in a limiting sense.

Embodiments of the present invention enable automated extraction of process flow data through parsing the source code. The parsed data is then used in the generation of a process flow model. In addition, embodiments of the present invention enable editing of the parser output to improve accuracy and reliability of the generated process flow model. The process flow model is generated in a format that is useable by a high level application (e.g. a decision support system) to analyze the data in making intelligent decisions. For example, the process flow model is analyzed to determine which tests should be run and the order in which the selected tests should be run.

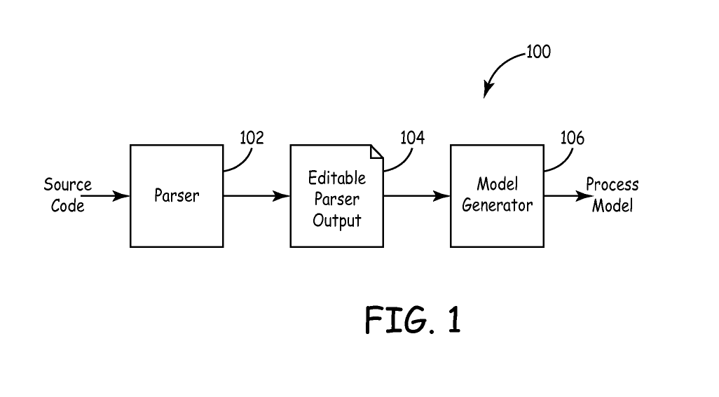

FIG. 1 is a high level block diagram of a system 100 for producing a process flow model from source code according to one embodiment of the present invention. System 100 includes parser 102 and model generator 106. Parser 102 is adapted to receive and parse source code for one or more programs. In this example, parser 102 is adapted to parse source code written using the Abbreviated Test Language for All Systems (ATLAS) (also known as Abbreviated Test Language for Avionics Systems). Alternatively, in other embodiments, parser 102 is adapted to parse source code written in other programming languages. Parser 102 is adapted to parse source code using a plurality of regular expressions (also known as regexes and patterns). Regular expressions are known to one of skill in the art and consist of strings used to match strings in the source code.

The use of regular expressions enables parser 102 to identify elements in the source code. For example, in this embodiment, parser 102 is adapted to use regular expressions to identify elements which indicate, among other things, tests to be run, outcomes of the test, and actions to be taken based on the outcome (also known as indictments). In this embodiment, indictments include, but are not limited to, additional tests to be run, and suggested repairs.

In order to associate identified elements with each other, parser 102 maintains one or more state variables. In particular, the state variables keep track of the current position in the process flow. For example, in this embodiment, state variables are used for the last test found and the outcome value found corresponding to the last test. In this way, as each indictment is found, it is related to a given test and outcome. In addition, the different identified tests are also related by the state variables. For example, in this embodiment, if a test is found after the last test without finding an outcome between the two tests, then the second test is determined to run regardless of the outcome of the prior found test. On the other hand, some tests are identified to be dependent on the outcome of a prior test, in which the subsequent tests are only run if a particular outcome occurs for the prior test.

Additionally, parser 102 is configurable such that it is capable of parsing variations in different source code files. For example, in this example, parser 102 is adapted to handle modified vocabularies and possible syntax distortions of the ATLAS code. These variations can cause the same regular expression to return different results for different source code files. In this embodiment, parser 102 uses a plurality of configuration files to handle the different variations. Each configuration file contains a set of regular expressions each set corresponding to a different variation. If the differences are mutually exclusive to each variation, then the different configuration files can be added together into one configuration file. However, in other embodiments, the differences are not mutually exclusive. Therefore, in such embodiments, a global configuration file is used for regular expressions which are common throughout the different variations, whereas non-mutually exclusive differences are stored in separate local configuration files for each variation. Parser 102 is configured to select a local configuration file and uses both the local and global configurations files in parsing a particular source code file.

In the embodiment in FIG. 1, parser 102 is also adapted to output the parsing results as editable parser output 104. By outputting editable parser output 104, embodiments of the present invention enable monitoring of the results to help ensure that models generated by model generator 106 are accurate. For example, in this embodiment, editable parser output 104 is an editable tabular file which is accessible and readable by a human. Therefore, a human can check for errors and/or inconsistencies, and then manually make any necessary corrections. In other embodiments, editable parser output 104 is output directly to a computer which automates revision and correction of the output. Alternatively, parser 102 is adapted to output the parsing results directly to model generator 106 without allowing for additional revision and editing prior to generating a model of the process flow.

Model generator 106, in this embodiment, is adapted to receive and process editable parser output 104. Model generator 106 generates the model based on the elements and relationships identified by parser 102. In particular, model generator 106, in this embodiment, formats the parser output into a tree structure model. For example, model generator 106 generates and outputs a tree structure in eXtensible Markup Language (XML) for each received editable parser output 104 in this example. The generated model can then be used by other high level applications to analyze the process flow.

In operation, parser 102 receives and parses the source code for one or more programs. Parser 102 parses the source code using regular expressions to identify elements and relationships between the identified elements. Parser 102 outputs the parsing results as editable parser output 104. A human, in this example, reviews editable parser output 104 for errors, such as redundancies, false positives, etc. Once editable parser output 104 has been reviewed and edited, it is input to model generator 106. Model generator 106 generates a tree structure model of the process flow based on an analysis of the edited data in editable parser output 104.

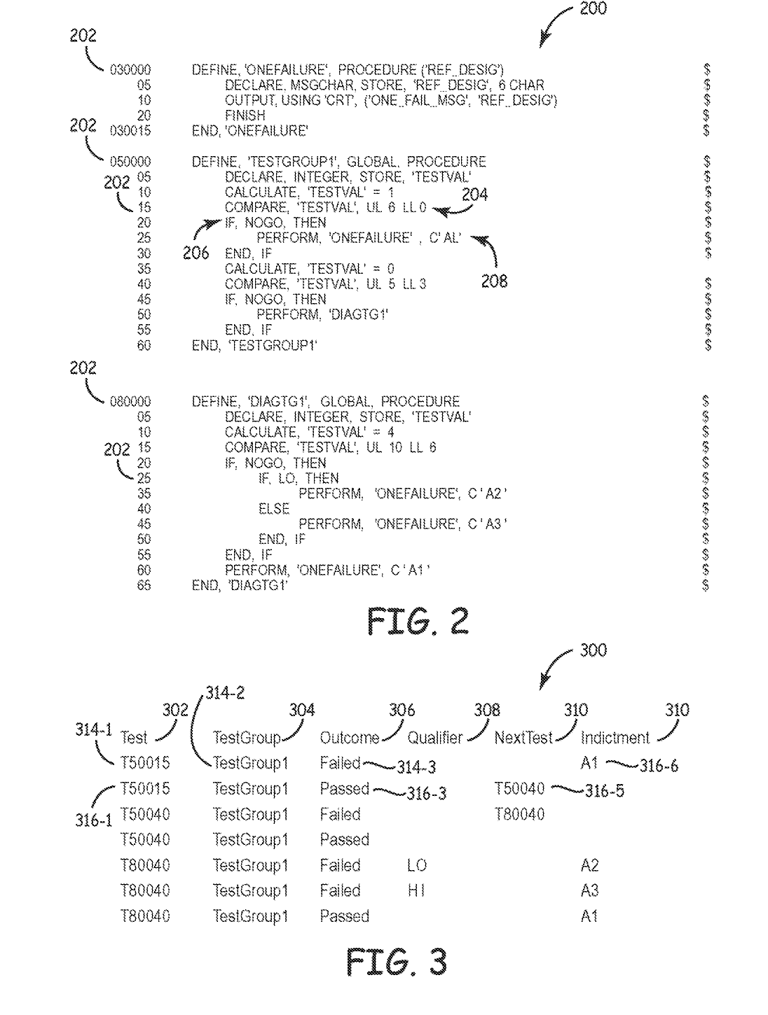

FIG. 2 is an exemplary source code 200 to be parsed according to one embodiment of the present invention. Source code 200 is parsed by a parser such as parser 102 in FIG. 1. In FIG. 2, the source code is exemplary ATLAS source code. It is to be understood that the source code shown in FIG. 2 is provided by way of example and not by way of limitation. In particular, it is to be understood that other programming languages and variations of the ATLAS source code are used in various embodiments of the present invention. As can be seen in FIG. 2, each line of source code 200 has a statement number 202. Statement numbers 202, in this example, consists of a six digit number at the beginning of each line. Notably, it is to be understood that although some lines do not display 6 digits at the beginning of the line, the missing digits are repeated from the first previous statement number 202 displaying 6 digits. For example, the first line of code shown in FIG. 2 has statement number “030000”. The second line only shows the number “05,” but it is to be understood that statement number 202 of the second line is “030005”.

A parser, such as parser 102, reads and stores statement numbers 202 and the corresponding strings. For each line, everything not part of statement number 202 is stored as a text string. The parser searches the text string of each line with configurable regular expressions. In this example, the regular expressions are implemented using the Practical Extraction and Report Language (Perl). However, it is to be understood that in other embodiments, other languages are used to implement the regular expressions, such as the Tool Command Language (Tcl). The regular expressions are used to find keywords indicating particular elements of the code, such as tests, outcomes, and indictments in this example. In addition, other values are also located using regular expressions. Such values include configuration, outcome qualifier (HI, LO), test group ID, and programming language constructs such as IF, WHILE, GOTO and procedure calls.

For example, the following is a configurable Perl regular expression used to locate keywords indicating a test in source code 200:

<Tests>

<Test regex=“\hat{ }\s*(COMPARE|VERIFY)\s*,”/>

</Tests>

The test regular expression looks for lines which begin with one or more spaces followed by either the word COMPARE or the word VERIFY. Each line identified using the test regular expression is a test. In this example, the test ID (e.g. unique identifying name) of each test is based on the statement number 202 corresponding to the line where each test is located. For example, a test is identified on line 204 using the regular expression above. Line 204 corresponds to the statement number “050015”. The test ID for this test is “T50015” based on the statement number. Alternatively, test IDs are determined differently in other embodiments. For example, in some embodiments, unique test IDs are found in the text strings of source code 200.

Similarly, the following configurable Perl regular expression is used to locate keywords indicating outcomes of a test (also referred to as a check):

<Check detectRegex=“\hat{ }\s*IF\s*,\s*NO\s*GO”>

<TrueOutcome value=“Failed”/>
<FalseOutcome value=“Passed”/>

</Check>

The check regular expression looks for lines beginning with one or more spaces followed by variations of the phrase “IF, NOGO”. Each line identified using the check regular expression indicates a check. A check is a point where the code branches in two or more directions. For example, in this embodiment, a check indicates a determination if the previous test failed or passed. If the “NOGO” flag is true, the expression “IF, NOGO” evaluates to true, and the outcome of the test is failed. This outcome is depicted by the statement ‘<TrueOutcome value=“Failed”/>’ in the check regular expression. If the “NOGO” flag is false, the expression “IF, NOGO” evaluates to false, and the outcome of the test is passed, as depicted by the statement ‘<FalseOutcome value=“Passed”/>’. The parser keeps track of whether it is inside the IF statement or not. In this way, it determines the outcome of the test and which branch of the code is being followed. In this example, the parser locates a check on line 206. For example, if the “NOGO” flag at this point is true, the expression “IF, NOGO” evaluates to true and the outcome of the test identified on line 204 is failed. The parser keeps track of what follows the IF statement identified on line 206 as the indictment corresponding to a failed test.

Additionally, the following configurable Perl regular expression is used in this example to locate keywords indicating indictments:
<Indictment detectRegex=“ˆ\s*PERFORM\s*,s*\‘ONEFAILURE\’” extractRegex=“C\‘([ˆ\′]+)\’”/>

The indictment regular expression looks for lines containing variations of the phrase “PERFORM, ‘ONEFAILURE’”. For example, the indictment regular expression identifies an indictment on line 208 corresponding to a failed test “T50015”. In addition, the indictment on line 208 corresponds to statement number “050025”. The indictment regular expression also extracts the failed part “A1” from the string “C‘A1’”. The ([ˆ\′]+) in the statement extractRegex=“C\‘([ˆ\′]+)\’” allows the parser to return whatever was between the first C’ and the final ‘ for the indictment.

It is to be understood that the regular expressions shown above are exemplary and that, in other embodiments, other regular expressions are used. In addition, other expressions are used to identify other elements such as outcome qualifiers.

FIG. 3 is an exemplary parser output 300 according to one embodiment of the present invention. Parser output 300 is provided by way of example and not by way of limitation. In particular, it is to be understood that other formats and structure are used in other embodiments. Parser output 300 is produced by parsing source code 200 with the regular expressions discussed above with regards to FIG. 2. Parser output 300 is a tabular file with six columns and multiple rows. Notably, although there are six columns in the example in FIG. 3, it is to be understood that in other embodiments, any appropriate number of columns are used. The columns in this exemplary embodiment are test column 302, test group column 304, outcome column 306, qualifier column 308, next test column 310, and indictment column 312. The values in the rows of parser output 300 relate found tests, test outcomes, outcome qualifiers, and indictments.

For example, the first entry 314-1 in test column 302 is “T50015”. This is the test ID of the first test found in source code 200. Test “T50015” is part of “Test Group 1” as indicated by corresponding entry 314-2 in test group column 304. The test groups are used in some embodiments to determine entry points in the source code. For example, a given source code file may have multiple entry or starting points. The test group ID is used to associate tests allowing for any of the multiple starting points to be used.

The corresponding entry 314-3 in outcome column 306 is “Failed” indicating a failed test “T50115”. In the same row, under indictment column 310, is entry 314-6 with the value “A1”. This information indicates that if the outcome of test “T50015” is a failed outcome, the corresponding action is “A1” where “A1” is a variable representing a particular action. Similarly, the second entry 316-1 in test column 302 is also “T50015”, but the corresponding entry 316-3 in outcome column 306 is “Passed”. In this row, there is an entry 316-5, “T50040”, in the next test column 310. This indicates that when the test “T50015” outcome is “passed”, the next test to perform is test “T50040”. Similar relationships between tests, outcomes and indictments are shown in parser output 300 for other tests found in source code 200 of FIG. 2.

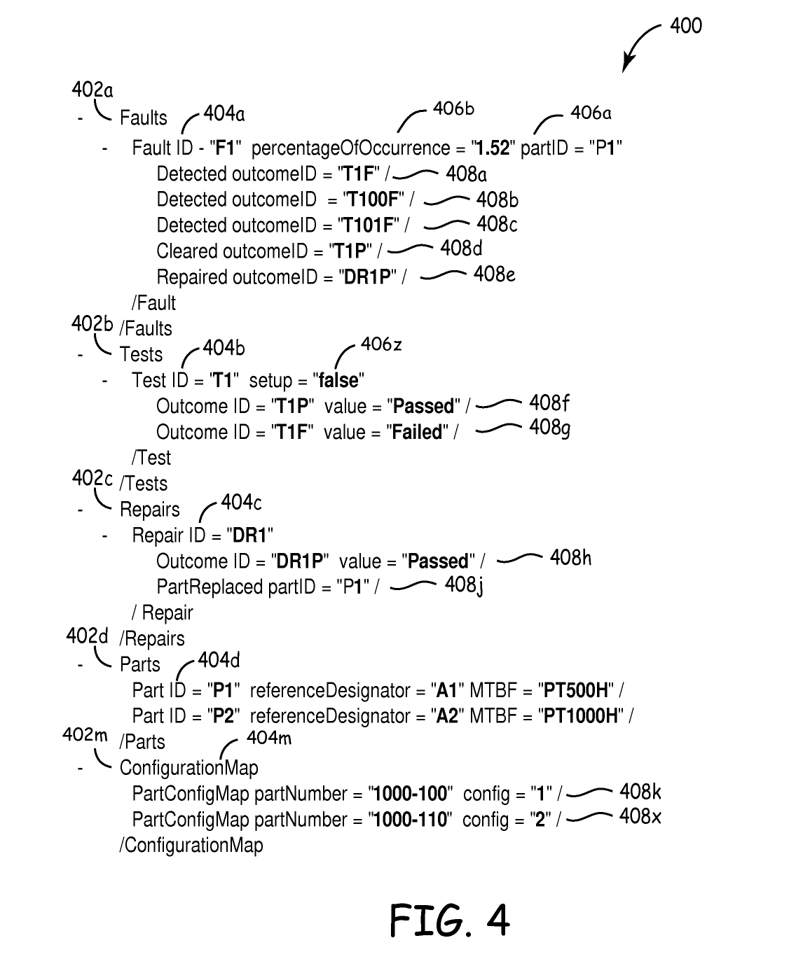

FIG. 4 is a portion of an exemplary process flow model 400 according to one embodiment of the present invention. Process flow model 400 is generated by a model generator, such as model generator 106, by analyzing a parser output, such as parser output 300.

As can be seen in FIG. 4, process flow model 400 comprises an XML tree structure with classes 402a-402n, sub-classes 404a-404m, attributes 406a-406z, and properties 408a-408x, where n is the total number of classes, m is the total number of sub-classes, x is the total number of properties, and z is the total number of attributes. In particular, the example in FIG. 4, contains classes 402 for Faults, Tests, Repairs, Parts and Configuration Map. However, it is to be understood that additional and/or different classes are used in other embodiments. Model 400 relates faults to the tests that detect them and to the repairs that the correct them. In addition, model 400 relates faults to the physical part where the fault occurs and model 400 contains a configuration map which indicates which parts are related to particular configurations of the electronic unit being tested.

For example, sub-class 404a represents the fault “F1” (identified by its fault ID) in FIG. 4 has an attribute 406a labeled “partID” which indicates the physical part where fault FI occurs. Similarly, attribute 406b indicates the percentage of occurrence of fault “F1”. This is useful to a high level application in making intelligent decisions regarding which tests to run and in which order. In other embodiments, other data useful to a high level application are included as attributes and properties.

In addition, sub-class 404a has properties 408a-408e. Properties 408a-408c indicate the test ID of the tests and test outcomes which detect the fault “F1” (e.g. outcomeID “T1F” indicates a failed outcome of test T1). Property 408d indicates which test outcome indicates that fault “F1” is not a problem (i.e. cleared outcome). Property 408e indicates which repair outcome indicates that the physical part has been repaired. Classes 404b-404m have similar properties and attributes. For example, sub-class 404b has properties 406f and 406g which indicate possible outcomes of test “T1”. Therefore, model 400 provides information regarding relationships between tests, faults and repairs such that a high level application can analyze model 400 and make intelligent decisions regarding which tests to run and in which order.

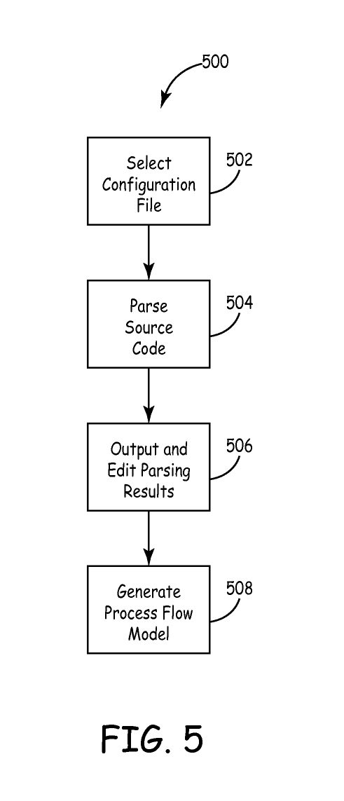

FIG. 5 is a flow chart showing a method 500 of generating a process flow model from source code according to one embodiment of the present invention. Method 500 is implemented by a system adapted to generate a process flow model, such as system 100 in FIG. 1. At 502, at least one configuration file is selected from a set of configuration files. Each configuration file contains regular expressions which correspond to variations in the source code. These variations can be modified vocabularies, syntax distortions, and/or different programming languages. By enabling the use and selection of different configuration files, the accuracy and functionality of a parser, such as parser 102, are increased. In this example, a user selects the at least one configuration file to be used.

At 504, the parser parses the source code using the regular expressions contained in the at least one selected configuration file. The parser steps through the source code line by line exploring the different branches of the source code process flow. The parser identifies keywords indicating particular elements as described above. In this example, the parser looks for keywords indicating, among other things, tests, checks, indictments, outcome qualifiers, test groups, configuration, etc. The parser keeps track of where in the process flow it is by updating one or more state variables as it processes each line of code. For example, in this example, the parser updates state variables for the last test found and the outcome value of the last test. Alternatively, additional or different state variables are used in other embodiments. For example, in some embodiments, an additional state variable for configuration is used. The configuration state variable is used to distinguish between two models of the same unit being tested by the source code. For example, if the unit being tested is an electronic component on an F/A-18 aircraft, a test failure may indicate different actions for model A than for model C. The configuration state variable keeps a record of when each model is being addressed in the source code.

At 506, the results of parsing the source code at 504 are output and edited. In this example, the results are output to an editable tabular file, such as output 300 above. This output is then reviewed and edited for errors, such as redundancy or missed elements. In this example, the reviewing and editing is performed by a human. However, in other embodiments, the reviewing and editing is automated by a computer and software. At 508, a model generator, such as model generator 106, uses the edited parser output to generate a model of the source code process flow. The model generator organizes the parser output into a tree structure relating the elements identified by the parser. In this example, the model generator relates each fault with the tests that detect it, and the recommended actions or repairs (i.e. indictments). In addition, the model generator, in this example, formats the parser output in a format that is useable by a high level application in analyzing the process flow. In particular, the model generator, in this example, formats the parser output into an XML file, such as model 400 above.

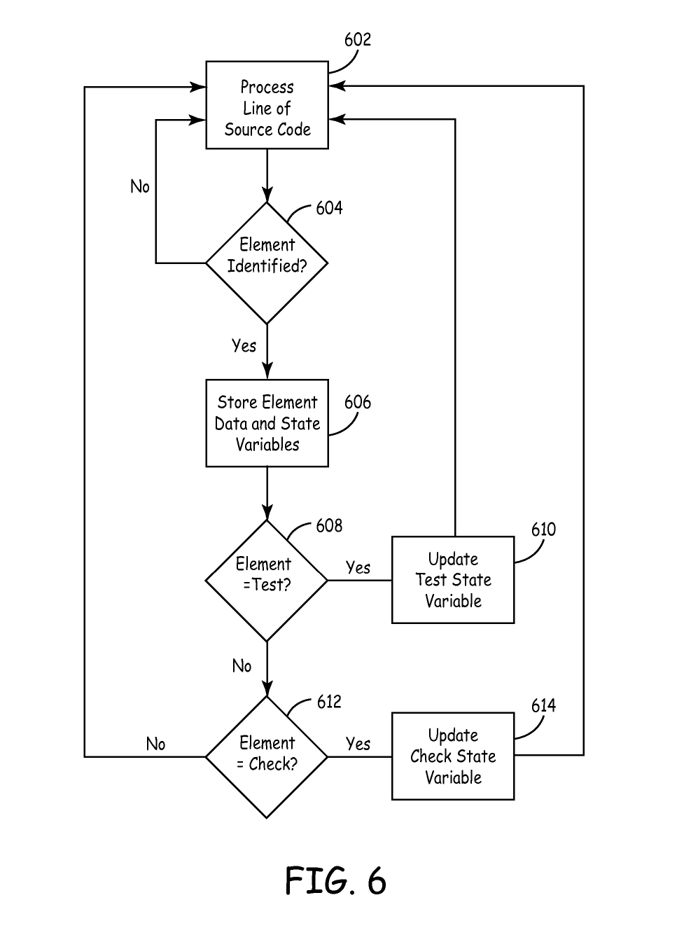

FIG. 6 is a flow chart showing a method 600 of parsing a source code according to one embodiment of the present invention. Notably, although method 600 is described here as a linear process, it is to be understood that two or more blocks may occur in parallel. At 602, a parser, such as parser 102, processes a line of source code. Processing the line of source code comprises using regular expressions to look for keywords indicating particular elements of the source code. In this example, the regular expressions are looking for keywords indicating tests, test outcomes, and indictments, etc. At 604, the parser determines if an element has been identified. If an element was not identified on that line of code, method 600 returns to 602 where the next line of code is processed.

If the parser finds an element at 604, the parser stores in memory the condition of the state variables and other data (e.g. type of element and relationship to other elements) related to the identified element at 606. The state variables, in this example, are lastTest and Outcome, representing the last test found and the outcome of the test (e.g. failed or passed), respectively. However, it is to be understood that in other embodiments, additional and/or different state variables are used. At 608, the parser determines if the element identified at 604 is a test. If the element is a test, the parser updates the lastTest state variable with the test ID of the identified test at 610. In this example the test ID is based on the statement number of the line of code, as described above. Alternatively, other protocols are used for determining test IDs in other embodiments. The parser then moves to the next line of code to be processed at 602. In this example, the next line of code to be processed is the line of code which linearly follows the line just processed unless the line just processed calls another line of code. If another line of code is called, the parser moves to that line and internally remembers from which line of code the new line was called. However, in other embodiments, the parser moves forward in a strictly linear fashion from one line to the next while keeping track of relationships between lines based on call statements. If the element identified at 604 is not a test, the parser determines if the element is a check at 612.

If the element is a check, the parser updates the Outcome state variable to indicate what outcome is being processed at 614. For example, as described above, the parser knows, based on keywords and regular expressions, whether or not it is inside an IF statement or not. In this way, the parser knows which outcome (e.g. passed, failed, fail lo, fail hi) is being processed. Method 600 then continues at 602 to process the next line of code as described above. In this way, the parser explores a branch of the code corresponding to a particular outcome. Additionally, the parser stores internally the value of the state variables for each line of code. As the parser recursively processes the source code, it is able to follow a different branch of the code for each check and avoid processing lines of code a second time by remembering the value of the state variables for each line of code. For example, when a line of code is reached, the parser does not process it again if the state variables are the same for the line of code as in a prior run.

The state variables are also used to reduce processing power and time spent on irrelevant branches of the code (e.g. branches that do not contain information relevant to the task at hand). For example, if a branch of code goes through a series of outputs to a user without providing information regarding suggested repairs, additional test, etc., the state variables associated with the start of the branch will be the same at the end of the branch. Since the state variables are the same when the branch starts and ends, that branch of the code will be ignored when the parser processes and outputs its results. Finally, if the element is not a check at 612, method 600 continues at 602 to process the next line of code as described above.

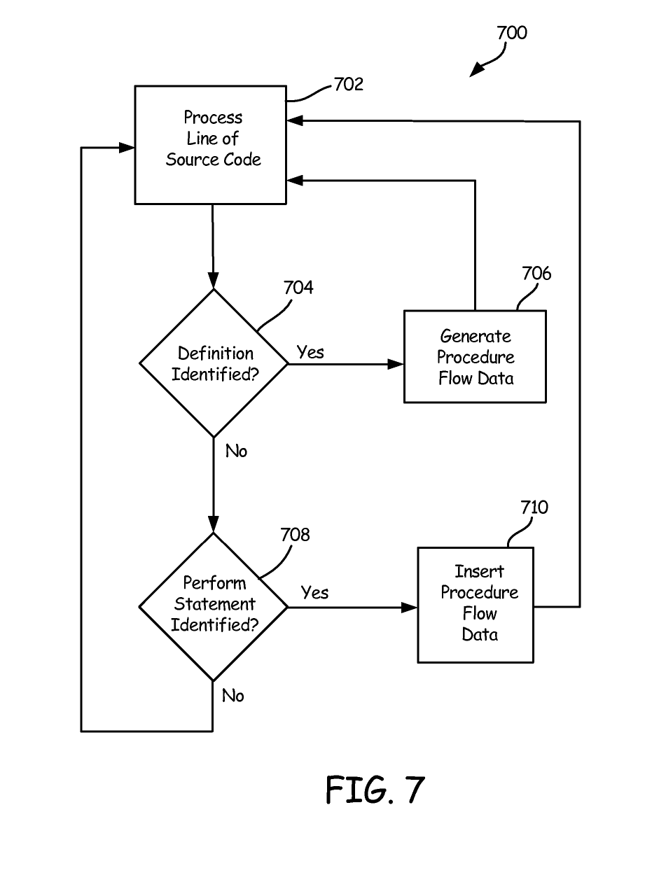

FIG. 7 is a flow chart showing a method 700 of parsing a procedure in source code according to one embodiment of the present invention. Procedures are sub-sections of the overall source code with a separate start and finish. Each procedure may include multiple tests, checks and indictments, etc. A procedure definition is identified by regular expressions and defines what tests, etc. are to be run in the procedure. For example, in this embodiment a regular expression searches for variations of the term “DEFINE”. At 702, a line of source code is processed. At 704 it is determined if a procedure definition is identified in the line of source code being parsed. If a procedure definition is identified at 704, the parser generates procedure flow data at 706. The parser generates the procedure flow data by following the procedure flow as if the procedure were being run in the source code. In other words, the parser pauses from following the overall source code flow to follow the different possible states in the procedure flow. In addition, the parser analyzes the procedure recursively to evaluate all possible branches of the procedure, as described above with regards to the overall source code process flow. Once the procedure flow data has been generated, method 700 returns to the line from where it entered the procedure and proceeds to the next line of code to be parsed, as described above.

If a procedure definition is not identified at 704, it is determined if a procedure perform statement is identified at 708. A procedure perform statement is a statement in the source code indicating that a particular procedure should be run. Procedure perform statements are also identified using regular expressions. For example, in this embodiment, regular expressions search for variations of the term “PERFORM”. If a perform procedure statement is identified at 708, data regarding the procedure flow for the particular procedure to be run is inserted into the parser output for the overall source code flow, at 710 (e.g. rows of data are entered into a parser output such as parser output 300 for the procedure flow). Once the procedure flow data has been inserted, method 700 continues at 702 where the next line of code is parsed. If a procedure perform statement is not identified at 708, method 700 continues at 702 where the next line of code is parsed as described above. Method 700 improves the performance of the parser since each procedure need only be evaluated once and can then be inserted into the parser results whenever a perform procedure statement is identified calling a particular procedure. Since a particular procedure may be called multiple times in several different places in the source code, method 700 decreases processing time and required memory since the data for a particular procedure need only be calculated and stored once.

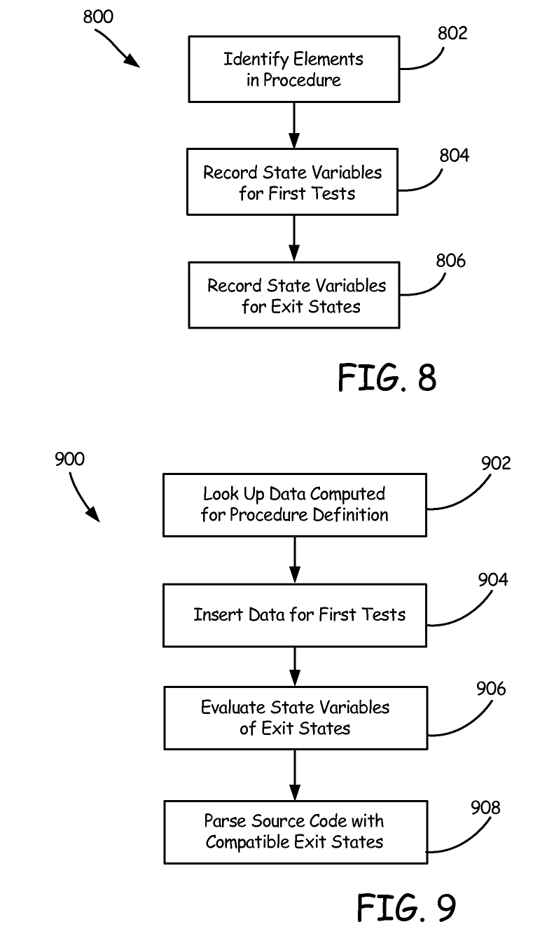

FIG. 8 is a flow chart showing a method 800 of generating a procedure flow according to one embodiment of the present invention. At 802 a parser identifies elements (e.g. tests, checks, indictments, etc.) in the procedure and records the values of state variables for each line of code in the procedure, as described above. At 804, the parser records the values of state variables and data regarding all tests which are reachable from the beginning of the procedure without encountering another test. These tests are also referred to as “first tests” or entry points in the procedure. At 806, the parser records the values of the state variables for each possible exit from the procedure (i.e. the exit states of the procedure). For example, if a procedure runs three tests (TEST1, TEST2, TEST3) and exits when any one of the three tests fails, the parser records four exit states for the procedure. The four exit states with state variables lastTest and outcome are as follows:

1. lastTest=TEST1, outcome=failed

2. lastTest=TEST2, outcome=failed

3. lastTest=TEST3, outcome=failed

4. lastTest=TEST3, outcome=passed

The state variable lastTest represents the last test found and outcome represents the test outcome of the last test found. Since the procedure will exit if any of the three tests fail, there is an exit state corresponding to each of those states. In addition, the procedure will exit once all of the tests have been run. Therefore, a fourth exit state is included indicating that TEST3 (the last test in the procedure) has run. It is to be understood that in other examples, exit states may contain additional and or different state variables, such as a state variable for configuration as discussed above. In addition, the exit states may be based on different criteria than a failed or passed test.

FIG. 9 is a flow chart showing a method 900 of inserting data regarding procedure flow into a parser output according to one embodiment of the present invention. Method 900 is implemented when a perform procedure statement is identified by a parser using regular expressions. At 902 the parser looks up the data computed when the procedure definition for the procedure being performed was analyzed, such as described above. At 904, the parser inserts into the parser output data relating the state variable values just prior to performing the procedure (e.g. the state variable values of the procedure's perform statement) with the possible “first tests” in the procedure. For example, the data inserted into the output identifies a relationship which indicates from what test and outcome the “first tests” of the procedure can be reached. At 906, the parser evaluates the possible exit states of the procedure to determine which exit states are compatible with the state variable values just prior to performing the procedure. For example, if a state variable, configuration, has a value indicating that configuration 1 is being evaluated, an exit state that is only valid for configuration 2 (as indicated by the configuration state variable for the exit state) would be incompatible. At 908, the parser recursively parses the source code with all the different compatible exit state values.

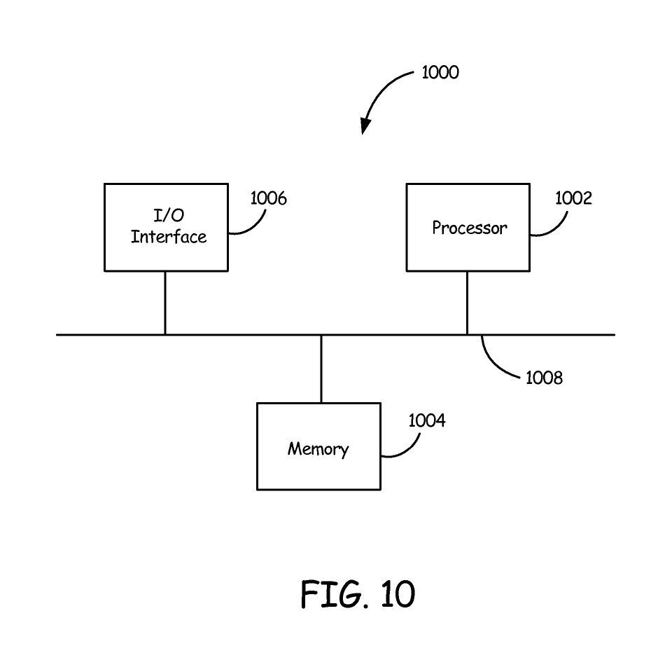

FIG. 10 is a high level block diagram of a processing unit 1000 according to one embodiment of the present invention. Processing unit 1000 is used, in some embodiments, to implement a parser and a model generator, such as parser 102 and model generator 106. Processing unit 1000 includes processor 1002, memory 1004, and input/output interface 1006 coupled together via bus 1008.

Memory 1004 includes any type of suitable medium such as floppy disks, conventional hard disks, DVD-RW, CD-RW, reprogrammable non-volatile memory such as flash memory and EEPROM, volatile memory such as dynamic RAM and static RAM, and any other existing or later developed suitable medium. Processor 1002 and memory 1004 are coupled together allowing processor 1002 to write to and store data in memory 1004 as well as retrieve stored data from memory 1004. For example, memory 1004 is used to store state variable values as well as data regarding identified elements in the source code (e.g. relationships, state variable values for each line, etc.).

Processor 1002 includes or interfaces with hardware components that support the parsing of source code and generation of a process flow model as described above. By way of example and not by way of limitation, these hardware components include one or more microprocessors, graphics processors, memories, storage devices, interface cards, and other components used to parse a source code file and to generate a process flow model from the parsed sourced code file. Additionally, processor 1002 includes or functions with software programs, firmware or computer readable instructions for carrying out various methods, process tasks, calculations, and control functions for the parsing of source code and the generation of a process model. The computer readable instructions, firmware and software programs are tangibly embodied on any appropriate medium used for storage of computer readable instructions including, but not limited to, all forms of non-volatile memory, including, by way of example and not by limitation, semiconductor memory devices, such as EPROM, EEPROM, and flash memory devices; magnetic disks such as internal hard disks and removable disks; magneto-optical disks; and DVD disks.

In operation, processing unit 1000 receives a source code file via input/output interface 1006. According to computer-readable instructions (stored in memory 1004 in this example), processor 1002 parses the source code file using regular expressions to identify certain elements of the source code, as described above. Data regarding the identified elements and relationships between the elements is stored in memory 1004. Once processor 1002 has completed parsing the source code file, the results are generated and output in a human-readable file via input/output interface 1006. Alternatively, the results are generated and output in a computer-readable file via input/output 1006. Once the file has been reviewed and edited, the edited results are input via input/output 1006. The edited results are then used by processor 1002 to generate a process flow model as described above. Notably, although processing unit 1000 is used, in this example, to both parse the source code file and generate the process flow model, it is to be understood that in other embodiments, a separate processing unit is used to parse the source code file and another processing unit is used to generate the process flow model.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of extracting process flow data from a source code, the method comprising:
parsing the source code with a plurality of regular expressions to identify a plurality of elements and at least one relationship between two or more identified elements; and
generating a model of the source code process flow based on the plurality of identified elements and the at least one relationship between two or more identified elements.

2. The method of claim 1, further comprising:
selecting at least one set of regular expressions from a plurality of non-exclusive sets of regular expressions, wherein each set contains at least one regular expression corresponding to a variation of the source code.

3. The method of claim 1, wherein parsing the source code further comprises:
updating one or more state variables based on identification of the plurality of elements.

4. The method of claim 3, wherein parsing the source code further comprises:
ignoring each branch in the source code in which the one or more state variables are the same at the beginning and end of the branch.

5. The method of claim 1, generating a model of the source code process flow further comprises generating a model formatted as an XML tree structure.

6. The method of claim 1, wherein parsing the source code further comprises parsing Abbreviated Test Language for All Systems (ATLAS) source code.

7. The method of claim 1, further comprising:
editing the parsed output prior to generating a model of the process flow.

8. The method of claim 1, wherein parsing the source code with a plurality of regular expressions to identify a plurality of desired elements further comprises:
generating procedure flow data for each procedure definition identified; and
inserting into a parser output the procedure flow data for a procedure each time a procedure perform statement is identified for the procedure.

9. The method of claim 8, wherein generating procedure flow data further comprises:
identifying elements in the procedure;
recording state variables for first tests which are reachable from the beginning of the procedure without encountering another test;
recording state variables for possible exit states.

10. The method of claim 9, wherein inserting into a parser output the procedure flow data further comprises:
inserting data into the parser output relating the state variable values of the procedure's perform statement with possible first tests in the procedure;
evaluating possible exit states to determine which exit states are compatible with the state variable values of the procedure's perform statement; and
parsing the source code with the compatible exit states.

11. A system adapted to analyze source code, the system comprising:
a parser adapted to parse a source code with a plurality of regular expressions to identify a plurality of elements and at least one relationship between two or more identified elements; and
a model generator adapted to generate a model of the source code process flow based on the plurality of identified elements and the at least one relationship.

12. The system of claim 1 1, wherein the parser is adapted to output the results of parsing the source code such that the output results are editable, and the model generator is adapted to import the edited parsed output.

13. The system of claim 1 1, wherein the parser is adapted to maintain one or more state variables based on one or more identified elements.

14. The system of claim 13, wherein the parser is further adapted to ignore branches in the source code process flow which start and end with the same state variable values.

15. A computer program product comprising:
a computer-usable medium having computer-readable code embodied therein for configuring a computer processor, the computer-readable code comprising:
first executable computer-readable code configured to cause a computer processor to parse a source code using at least one regular expression in order to identify a plurality of elements and at least one relationship between two or more identified elements; and
second executable computer-readable code configured to cause a computer processor to generate a model of the source code process flow based on the plurality of identified elements and the at least one relationship.

16. The computer program product of claim 15, wherein the first executable computer-readable code is farther configured to cause a computer processor to output the results of parsing the source code in an editable format, and the second executable computer-readable code is further configured to cause a computer processor to generate a model based on the edited parsing results.

17. The computer program product of claim 15, further comprising:
third executable computer-readable code configured to cause a computer processor to select at least one set of regular expressions from a plurality of non-exclusive sets of regular expressions, wherein each set of regular expressions corresponds to a different variation of the source code.

18. The computer program product of claim 15, wherein the first executable computer-readable code further comprises executable computer readable code configured to cause a computer processor to parse Abbreviated Test Language for All Systems (ATLAS) source code.

19. The computer program product of claim 15, wherein the first executable computer-readable code is further configured to cause a computer processor to update the value of one or more state variables based on one or more of the elements identified.

20. The computer program product of claim 19, wherein the first executable computer-readable code is further configured to ignore branches of source code which start and end with the same state variable values.
